(19) United States
(12) Patent Application Publication
(10) Pub. No.: US 2025/0191343 A1
(43) Pub. Date: Jun. 12, 2025

(54) DEVICE AND METHOD WITH DETECTION OF OBJECTS FROM IMAGES

(71) Applicant: Samsung Electronics Co., Ltd., Suwon-si (KR)

(72) Inventors: Jiyeoup JEONG, Suwon-si (KR); Heewon PARK, Suwon-si (KR); Dae Ung JO, Suwon-si (KR)

(73) Assignee: Samsung Electronics Co., Ltd., Suwon-si (KR)

(21) Appl. No.: 18/658,019

(22) Filed: May 8, 2024

(30) Foreign Application Priority Data
Dec. 8, 2023 (KR) 10-2023-0177788

(51) Int. Cl. G06V 10/774; G06V 10/25; G06V 10/776; G06V 10/778; G06V 10/94; G06V 20/58

(52) U.S. Cl. CPC G06V 10/774; G06V 10/25; G06V 10/776; G06V 10/778; G06V 10/945; G06V 20/58

(57) ABSTRACT

A method performed by an electronic device includes: obtaining an image captured by a sensor; detecting, in the image, a static object region corresponding to a static object of the image, wherein the detecting is performed by applying an object detection model to the image; determining whether to collect the image as part of a training dataset based on an accuracy level of the detected static object region; and determining a ground truth static object region for the static object of the image from space-occupancy information of the static object with respect to the image collected as part of the training dataset.

### CROSS-REFERENCE TO RELATED APPLICATIONS

This application claims the benefit under 35 USC § 119(a) of Korean Patent Application No. 10-2023-0177788, filed on Dec. 8, 2023, in the Korean Intellectual Property Office, the entire disclosure of which is incorporated herein by reference for all purposes.

### BACKGROUND

### 1. Field

The following description relates to object detection.

### 2. Description of Related Art

The driving environment of an autonomous vehicle may vary depending on the country or region where it is driving. In addition, in a camera attached to the autonomous vehicle, unique image characteristics of a sensor, such as brightness, saturation, and contrast ratio, may vary depending on the manufacturer. The changes in the driving environment may cause the autonomous vehicle to fail to recognize an object. To prevent this, a recognizer of the autonomous vehicle may be stabilized by re-training the autonomous vehicle in the current driving environment.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method performed by an electronic device includes: obtaining an image captured by a sensor; detecting, in the image, a static object region corresponding to a static object of the image, wherein the detecting is performed by applying an object detection model to the image; determining whether to collect the image as part of a training dataset based on an accuracy level of the detected static object region; and determining a ground truth static object region for the static object of the image from space-occupancy information of the static object with respect to the image collected as part of the training dataset.

The determining of whether to collect the image may include: determining a reference static object region in which a space occupied by the static object is viewed from a viewpoint and viewing direction of the sensor, based on the space-occupancy information of the static object and localization information of the sensor, the localization information including a location and orientation of the sensor; and determining the accuracy level of the detected static object region based on a comparison between the static object region and the reference static object region.

The detecting of the static object region may include detecting sub-regions of the image respectively corresponding to static objects of the image, including the static object, determining reference static object sub-regions of the static objects from the detected sub-regions, and the determining of the accuracy level of the detected static object region includes: determining detection states for the respective static objects, wherein each static object's detection state is determined based on its detected sub-region and its reference sub-region, and wherein static object's detection state indicates whether the detection of the static object is valid or invalid; and determining the accuracy level of the detected static object region based on a ratio of a number of valid detection states and a number of invalid detection states.

The method may further including: displaying the detected static object region, wherein the determining of whether to collect the image is based on detecting a user input requesting a collection of the image.

The determining of the ground truth static object region may include: obtaining, for candidate calibration parameter sets, respectively corresponding units of candidate localization information, each obtained by calibrating localization information of the sensor using a corresponding candidate calibration parameter set; obtaining candidate static object regions of the respective units of candidate localization information, wherein each candidate static object region is obtained from a view of a three-dimensional space occupied by the static object as viewed from a viewpoint direction of the corresponding candidate localization information; and determining, from among the candidate static object regions, the ground truth static object region based on comparison between each candidate static object region with the static object region.

The determining of the ground truth static object region may include: determining, for each candidate static object region, a similarity level between the static object region and a corresponding candidate static object region based on a number of pixels classified into the same class in the static object region and in a corresponding candidate static object region; and determining, to be the ground truth static object region, from among the candidate static object regions, a candidate static object region with a maximum similarity level.

Each candidate calibration parameter set may include a position delta and an orientation delta.

The sensor may be mounted on a moving object, and the obtaining the image, the detecting the static object region, the determining whether to collect the image, the determining the ground truth static object region, and detecting an object may be performed while the moving object travels, and the object may be the static object or another static object.

The method may further include controlling driving of the moving object based on a result obtained by the detecting of the object.

The method may further include: determining a loss value for adaptive learning based on a difference between the static object region and the ground truth static object region; and updating a parameter of the object detection model based on the determined loss value for adaptive learning.

In another general aspect, a method performed by an electronic device includes: obtaining an image captured by a sensor; and detecting, in the image, a static object region corresponding to a static object of the image, wherein the detecting is performed by applying an object detection model to the image, wherein the object detection model is an adaptively learned model, based on a training dataset, which comprises a training image with respect to a training static object, and a ground truth static object region mapped to the training image, and wherein the ground truth static object region is determined to be a region corresponding to the training static object of the training image from space-occupancy information of the training static object.

In another general aspect, a method performed by an electronic device includes: obtaining an image captured by a sensor, the sensor having an associated pose including a location and an orientation; detecting, by a neural network model, a static object in the image, the detecting including identifying a region of the image corresponding to the static object; generating a ground truth region of the static object by taking a projection, from a candidate pose that is based on the pose of the sensor, of a three-dimensional object space corresponding to the static object; retraining the neural network model based on the ground truth region and the image; and detecting a second static object in a second image using the retrained neural network model.

The image may be an image of a physical scene that includes static object, and the three-dimensional object space may be derived from a point cloud sensed from the physical scene.

In another general aspect, an electronic device includes: one or more processors configured to: obtain an image captured by a sensor, detect in the image a static object region corresponding to a static object of the image, wherein the detecting is performed by applying an object detection model to the image; determine whether to collect the image as part of a training dataset based on an accuracy level of the detected static object region; and determine a ground truth static object region for the static object of the image from space-occupancy information of the static object with respect to the image collected as part of the training dataset.

The one or more processors may be further configured to: determine a reference static object region in which a space occupied by the static object is viewed from a viewpoint and viewing direction of the sensor, based on the space-occupancy information of the static object and localization information of the sensor, the localization information including a location and orientation of the sensor; and determine the accuracy level of the detected static object region based on a comparison between the static object region and the reference static object region.

The one or more processors may be configured to: detect the static object region including partial regions respectively corresponding to static objects, including the static object, that are represented in the image; determine the reference static object region, which includes reference sub-regions respectively corresponding to the static objects; determine, for each of the static objects, whether detection for a corresponding static object is valid or invalid, based on a partial region and a partial reference region corresponding to a corresponding static object; and determine the accuracy level of the detected static object region based on a number of validly detected static objects.

The one or more processors may be configured to: obtain, for each of candidate calibration parameter sets, respectively corresponding units of candidate localization information, each obtained by calibrating localization information of the sensor using a corresponding candidate calibration parameter set, the localization information of the sensor including a position and an orientation; obtain candidate static object regions of the respective units of candidate localization information, wherein each candidate static object region is obtained from a view of a three-dimensional space occupied by the static object as viewed from a viewpoint direction of the corresponding candidate localization information; and determine, from among the candidate static object regions, the ground truth static object region based on comparison between each candidate static object region with the static object region.

The one or more processors may be configured to: determine, for each candidate static object region, a similarity level between the static object region and a corresponding candidate static object region based on a number of pixels classified into the same class in the static object region and a corresponding candidate static object region; and determine, to be the ground truth static object region, from among the candidate static object regions, a candidate static object region with a maximum similarity level.

Each of the candidate calibration parameter sets may include a position delta and an orientation delta, and each unit of candidate localization information may be determined by changing the position and orientation of the localization information by the position delta and the orientation delta of a corresponding candidate localization parameter set.

The sensor may be mounted on a moving object, and the one or more processors are configured to control driving of the moving object based on a result obtained by detecting the static object or another static object.

The one or more processors may be configured to: determine a loss value for adaptive learning based on a difference between the static object region and the ground truth static object region; and update a parameter of the object detection model based on the determined loss value for adaptive learning.

Other features and aspects will be apparent from the following detailed description, the drawings, and the claims.

### BRIEF DESCRIPTION OF THE DRAWINGS

FIG. 1 illustrates an example of a method performed by an electronic device, according to one or more embodiments.

FIG. 2 illustrates an example of determining whether to collect an image of an electronic device, according to one or more embodiments.

FIG. 3 illustrates an example of an electronic device determining a ground truth static object region, according to one or more embodiments.

FIG. 4 illustrates an example of three axes relative to a vision sensor or a moving object, according to one or more embodiments.

FIG. 5 illustrates an example of obtaining an image related to driving of a moving object when a vision sensor is mounted on the moving object, according to one or more embodiments.

FIG. 6 illustrates an example of a method performed by a static object detection system, according to one or more embodiments.

FIG. 7 illustrates an example configuration of an electronic device, according to one or more embodiments.

FIG. 8 illustrates an example configuration of an object detection system, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

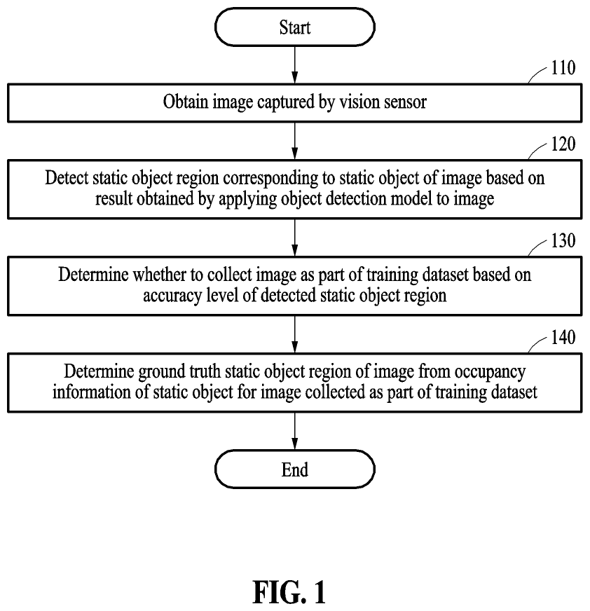

FIG. 1 illustrates an example of a method performed by an electronic device, according to one or more embodiments.

The electronic device may collect an image to form a training dataset for adaptive learning of an object detection model based on an accuracy level of a static object region detected, from the image, by the object detection model.

In operation 110, the electronic device may obtain an image captured by a vision sensor.

The vision sensor may be mounted on a moving object. The vision sensor may collect information related to the driving of the moving object. The image captured by the vision sensor may be generated by sensing data (e.g., image data) for a sensing physical region in the view of the vision sensor (e.g., near the moving object). For example, the vision sensor may include a camera sensor. The camera sensor may generate image data as sensing data by receiving and sensing light (e.g., light in the visible light band) reflected from physical points (e.g., points on an object). The image captured by the vision sensor may be a two-dimensional (2D) flat image.

The vision sensor is mainly described as including the camera sensor but is not limited thereto. For example, the vision sensor may include at least one of the camera sensor, a radar sensor, a lidar sensor, or an ultrasonic sensor. The radar sensor may generate radar data by radiating and receiving a radar signal. The lidar sensor may generate lidar data by radiating and receiving light. The ultrasonic sensor may generate ultrasonic data by radiating and receiving ultrasonic waves.

In operation 120, the electronic device may detect a static object region corresponding to a static object of the image based on a result obtained by applying the object detection model to the image.

The object detection model may be generated and/or trained to output information about a region corresponding to an object in the image by being applied to the image. The object detection model may be implemented based on a machine learning model and, for example, may include a neural network (e.g., a convolutional neural network (CNN)).

The static object may be disposed in a fixed pose in a three-dimensional (3D) stereoscopic space corresponding to a sensing range of the vision sensor. “Pose” is used herein to refer to a 3D location and a 3D orientation, thus a fixed pose includes a fixed location and a fixed orientation. For example, the static object may include a lane boundary (hereinafter, also referred to as a ‘lane line’), road, guardrail, and/or sign, as non-limiting examples. The road may be a street on which a vehicle travels and may include a lane. The lane may be distinguished by the lane boundary. The lane boundary is a type of road marking and may be a line that defines the lane. For example, the lane boundary may be a solid or dashed line painted on the road surface.

In operation 130, the electronic device may determine whether to collect the image as part of the training dataset based on the accuracy level of the detected static object region. The accuracy level of the detected static object region may indicate the object-detection performance of the object detection model for a certain image. When the image is determined to be collected as part of the training dataset, the image may also be referred to as a ‘training image,’ and the static object shown in the image may also be referred to as a ‘training static object.’

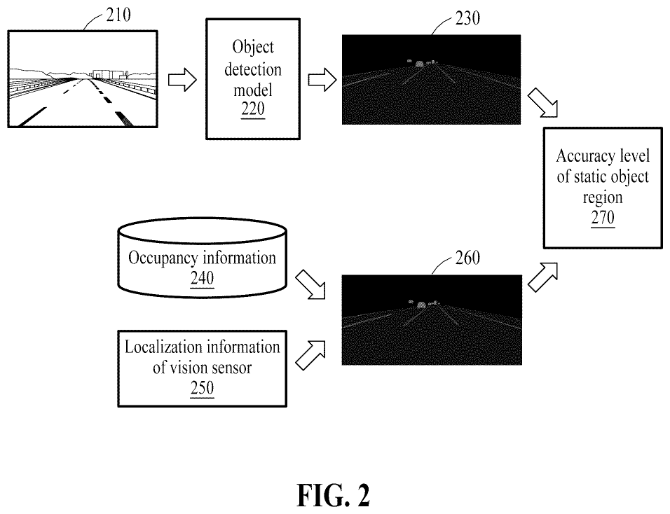

The accuracy level of the detected static object region may be determined based on occupancy information (i.e., space-occupancy information) of the static object and/or a user input. The determination of the accuracy level of the detected static object region is described in detail below with reference to FIG. 2.

Depending on the surrounding environment (e.g., the weather or lighting) of the vision sensor (or the moving object), the properties (e.g., texture or image quality) of the captured image may vary. When the properties of the captured image vary due to the surrounding environment of the vision sensor, the performance of the object detection model may be degraded. The electronic device may collect an image with degraded performance as part of the training dataset that is to be used for adaptive learning of the object detection model. For example, the electronic device may obtain an image captured in a poor environment (e.g., bad weather, fog, or inside tunnels) and may collect the image captured in the poor environment as part of the training dataset for adaptive learning.

The electronic device may determine to collect the image as part of the training dataset when the accuracy level of the detected static object region is less than or equal to a threshold accuracy level (i.e., when re-training would likely be beneficial). The electronic device may determine not to collect the image as part of the training dataset when the accuracy level of the detected static object region exceeds the threshold accuracy level.

In operation 140, the electronic device may determine a ground truth static object region of the image from the occupancy information of the static object for the image collected as part of the training dataset.

The occupancy information, for each partial region (e.g., a voxel), may include (i) information on whether a corresponding partial region is occupied by an object and/or (ii) information (e.g., a class) on an object occupying a corresponding partial region in the 3D stereoscopic space. The occupancy information may include partial regions, and a state of each partial region may store one of three states: occupied, un-occupied, or unknown. The occupancy information of a partial region may further include information indicating a class for the object occupying a corresponding partial region (when the partial region has the occupied state). The class may be classified according to a category of the static object, and for example, the class for the static object may include a lane line class, road class, sign class, and/or guardrail class.

Regarding determining the ground truth static object region, the electronic device may not immediately determine the ground truth static object region based solely on the occupancy information and the positioning information, but may perform a calibration to determine a more accurate ground truth static object region. This may allow for the determination of an accurate ground truth static object region that overcomes errors contained in the occupancy information and/or positioning information.

The occupancy information may include information on a space occupied by an object obtained from point cloud data. The point cloud data may be obtained based on a sensor (e.g., a lidar or radar sensor) that is different from the vision sensor used to obtain the image, and the obtained occupancy information may be constructed independently (e.g., prior to the capture of the image) from the processing of the vision sensor.

For example, the occupancy information may be/include an occupancy map. The occupancy map may represent occupancy information on a target region. The occupancy map may be/include a volume of voxels in which the target region is divided when the target region is a 3D stereoscopic region, and each voxel may have a voxel value indicating a state of a corresponding voxel. For example, a first voxel value (e.g., −1) may indicate that a state of a corresponding voxel is unknown. A second voxel value (e.g., 0) may indicate that a state of a corresponding voxel is un-occupied. A third voxel value (e.g., 1) may indicate that a state of a corresponding voxel is occupied by the static object of a first class (e.g., the lane line class). A fourth voxel value (e.g., 2) may indicate that a state of a corresponding voxel is occupied by the static object of a second class (e.g., the road class). The occupancy map may also be referred to as a ‘precision road map.’

The occupancy information of the static object may include information indicating a region occupied by the static object (the static object of the occupancy information). For example, the occupancy information of the static object may include information on a space (e.g., a 3D stereoscopic space) occupied by the static object.

The electronic device may determine the ground truth static object region based on the occupancy information of the static object and localization information of the vision sensor. The electronic device may determine a viewpoint and/or a viewpoint direction of the vision sensor based on the localization information of the vision sensor. The electronic device may determine a region that as viewed from the perspective of the image when a space (e.g., a space occupied by the static object) indicated by the occupancy information of the static object is viewed from the viewpoint and/or the viewpoint direction of the vision sensor. The localization information may indicate a pose of the sensor, i.e., a 3D location and a 3D orientation.

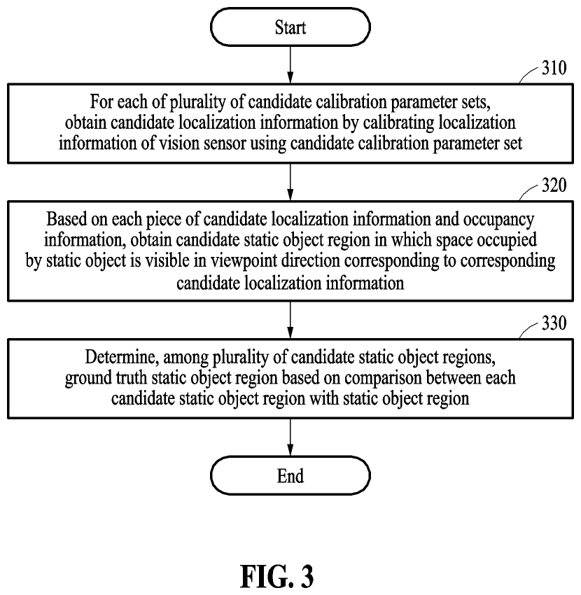

The electronic device may determine the ground truth static object region among regions determined through calibration (adjustment) of the localization information of the vision sensor. An example of an operation of determining the ground truth static object region through the calibration of the localization information of the vision sensor is described in detail below with reference to FIG. 3.

The electronic device may form a training pair by pairing the image (e.g., the training image) with the ground truth static object region determined based on the image (e.g., the training image). The image (e.g., the training image) included in the training pair and the ground truth static object region may be used for adaptive learning/training of the object detection model.

The electronic device may detect the static object from the image captured by the vision sensor, and may do so using an adaptively learned object detection model based on the training dataset including the training image and the determined ground truth static object region.

For example, the electronic device may obtain the image (e.g., which is different from the training image) captured by the vision sensor. The electronic device may detect the static object region corresponding to the static object of the image based on a result obtained by applying the object detection model to the image. The object detection model may be an adaptively learned model that has been based on the training dataset, which includes the training image (for a training static object) and the ground truth static object region mapped to the training image. The ground truth static object region may be determined to be a region corresponding to the training static object from occupancy information of the training static object. The collection of the training image and the ground truth static object region may be performed based on operations 110 to 140 of FIG. 1 described above.

The electronic device may obtain the adaptively learned object detection model based on the training dataset including the image and the ground truth static object region.

The electronic device may perform adaptive learning on the object detection model based on at least a portion of the collected training dataset. For example, the electronic device may determine a loss value for the adaptive learning based on the difference between the static object region and the ground truth static object region. The electronic device may update a parameter of the object detection model based on the determined loss value.

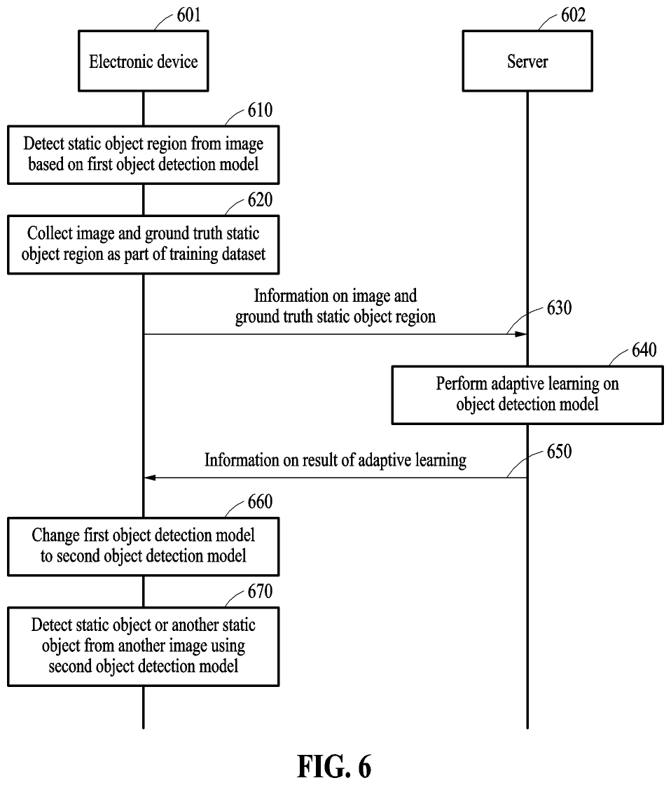

The electronic device is not itself required to perform adaptive learning (e.g., determine the loss value or update the parameter of the object detection model) on the object detection model. In some implementations, the electronic device may transmit at least a portion of the collected training dataset to a server and may receive information on the adaptively learned object detection model from the server. The performance of adaptive learning on the object detection model by the server is described below with reference to FIG. 6.

The electronic device may detect the static object or another static object from another image captured by the vision sensor after the adaptively learned object detection model is obtained. For example, the electronic device may obtain the adaptively learned object detection model based on the image which is captured in a poor environment. The adaptively learned object detection model may have improved performance of detecting an object from an image captured in a worse environment than in an environment before adaptive learning. Accordingly, the electronic device may more accurately detect the static object (or another static object) from another image using the adaptively learned object detection model than it would using an object detection model before adaptive learning, even when the other image is captured in a poor environment.

FIG. 2 illustrates an example of determining whether to collect an image of an electronic device, according to one or more embodiments.

The electronic device may detect a static object region 230 of an image 210 based on a result obtained by applying an object detection model 220 to the image 210. The electronic device may determine an accuracy level 270 of the static object region 230.

The electronic device may determine a reference static object region 260 in which a space occupied by a static object as viewed in a viewpoint direction of a vision sensor, based on occupancy information 240 and localization information 250 of the vision sensor.

The reference static object region 260 may be a region determined to correspond to the static object of the image 210, and the determining may be based on the occupancy information 240 and the localization information 250 of the vision sensor. For example, the electronic device may determine a viewpoint and/or a viewpoint direction of the vision sensor (relative to the occupancy information 240) corresponding to the localization information 250 of the vision sensor corresponding to when the image 210 was captured. The electronic device may determine, from among various possible regions (generally, all of the visible region, however a portion of the visible region is also possible) as viewed from the perspective of the image 210, a region to be the reference static object region 260 when a space indicated by a region occupied by the static object in the occupancy information 240 of the static object is viewed from the determined viewpoint and/or viewpoint direction of the vision sensor. For example, the reference static object region 260 may be determined based on a region in which a static object space is projected onto an image plane corresponding to the image 210 based on the occupancy information 240 in the viewpoint direction of the vision sensor.

For reference, the reference static object region 260 may be obtained as a region corresponding to the static object from the occupancy information 240 by using the localization information 250 of the vision sensor without a change thereto. In contrast, a ground truth static object region may be obtained as a region corresponding to the static object from the occupancy information 240 by calibrating the localization information 250 and then using the calibrated localization information 250 of the vision sensor as calibrated from the localization information 250 of the vision sensor. The electronic device may skip calibrating the localization information 250 of the vision sensor to obtain the ground truth static object region, and in this case, the reference static object region 260 may be the same as the ground truth static object region.

As described above with reference to FIG. 1, the occupancy information 240 may be constructed independently from sensing data obtained by the vision sensor that captures the image 210, so the static object region 230 derived by the object detection model 220 may be independent (e.g., different) from the reference static object region 260. The electronic device may determine that the result of the object detection model 220 is inaccurate when a difference between the static object region 230 and the reference static object region 260 is greater than or equal to a threshold.

The electronic device may determine the accuracy level 270 of the static object region 230 based on a comparison between the static object region 230 with the reference static object region 260. For example, the accuracy level 270 of the static object region 230 may correspond to the degree of registration between the static object region 230 that is detected and the reference static object region 260. For example, the accuracy level 270 of the static object region 230 may have a maximum possible value (e.g., 1) when the static object region 230 that is detected is the same as the reference static object region 260. For example, the accuracy level 270 of the static object region 230 may have a greater value the wider an overlapping region between the static object region 230 that is detected and the reference static object region 260. In other words, the more the static object region 220 and the reference static object region 260 agree, the higher the accuracy level 270.

The electronic device may detect partial regions respectively corresponding to static objects included in the static object region 230 or the reference static object region 260, and for each static object, the corresponding static object region 230 and reference static object region 260 may be compared.

For example, the electronic device may detect the static object region 230 including the partial regions respectively corresponding to one or more static objects that are visible from the perspective of the image 210. For example, using lane markers as examples of static objects, the electronic device may detect four partial regions (e.g., a first partial region, a second partial region, a third partial region, and a fourth partial region) respectively corresponding to four static objects (e.g., a first static object, a second static object, a third static object, and a fourth static object) from the image 210.

The electronic device may determine the reference static object region 260 including partial reference regions respectively corresponding to one or more static objects. For example, the electronic device may determine four partial reference regions (e.g., a first partial reference region, a second partial reference region, a third partial reference region, and a fourth partial reference region) respectively corresponding to the four static objects (e.g., the first static object, the second static object, the third static object, and the fourth static object) from the image 210, based on the occupancy information 240 and the localization information 250 of the vision sensor. The electronic device may determine a partial reference region corresponding to a corresponding static object, based on portions of the occupancy information 240 respectively corresponding to the static objects and based on the localization information 250 of the vision sensor.

The electronic device, for each of one or more static objects, may determine whether the detection of a corresponding static object is valid or invalid, based on a partial region and a partial reference region corresponding to a corresponding static object. For example, the electronic device, for each static object, may determine, among pixels of the image 210, whether the detection of a corresponding static object (in the image 210) is valid or invalid based on a ratio of the number of second pixels for the number of first pixels. For example, the Intersection over Union (IoU) metric may be used. Given a first partial region of the static object region 230 (from the image 210) and a corresponding (e.g., by image location) second partial region of the reference static object region 260, the IoU is the area of their intersection over the area of the union. More precisely, the number of first pixels is the number of pixels included in either the first or second partial region. The number of second pixels is the number of pixels included in both the first and second partial regions.

The electronic device may determine the overall accuracy level 270 of the static object region 230 based on an object ratio of the number of one or more static objects to the number of those static objects determined to be valid (e.g., by their IoUs). For example, the electronic device may determine that the accuracy level 270 satisfies a threshold accuracy level when the object ratio exceeds a threshold ratio.

In FIG. 2, it is mainly described that the electronic device determines the accuracy level 270 of the static object region 230 based on the comparison between the static object region 230 with the reference static object region 260 but is not limited thereto. For example, the electronic device may determine the accuracy level 270 of the static object region 230 based on a user input. To facilitate this, the electronic device may display the a graphic representation of the static object region 230 overlayed on the image 210.

The electronic device may determine to collect the image 210 (into a training set being constructed) based on detecting the user input, which indicates that the image 210 should be collected. For example, the electronic device may provide the image 210 or the static object region 230 that is detected to a user on a display. The user may verify the static object region 230 provided on the display, and when the user determines that the static object region 230 is inaccurate, the user may input the user input to request the electronic device to collect the image 210.

To summarize, the collect the image 210 when the accuracy level 270 of the static object region 230 is less than or equal to the threshold accuracy level of the threshold and/or when the user inputs a request for the collection of the image 210.

FIG. 3 illustrates an example of an operation in which an electronic device determines a ground truth static object region, according to one or more embodiments.

The electronic device may calibrate localization information of a vision sensor and may determine the ground truth static object region based on the calibrated localization information of the vision sensor. To summarize the following description of FIG. 3, localization information (e.g., a 3D pose (a 3D location and 3D orientation)) may be associated with the vision sensor. Permutations of the localization information may be obtained. Specifically, units of candidate localization information (candidate permutations/variants of the localization information, i.e., candidate poses of the vision sensor) may be obtained by applying candidate calibration parameter sets (e.g., pose deltas, i.e., a location delta and an orientation delta) to the localization information. The term “delta” refers to scalar values, transform matrices, or the like.

Operation 310 may start with candidate calibration parameter sets. Each candidate calibration set may be a different pose delta/transform (a 3D location delta and a 3D orientation delta). For each candidate calibration parameter set (candidate pose delta) the electronic device may obtain corresponding candidate localization information (a candidate pose), which may be done by applying the corresponding candidate calibration parameter set (candidate pose delta) to the localization information of the vision sensor (a pose) to produce calibrated localization information (e.g., a pose moved and reoriented according to the candidate pose delta). As noted above, the localization information of the vision sensor may include pose information (location information and orientation information). The location information may indicate a location/position of the vision sensor (or a moving object equipped with the vision sensor) in three dimensions. The orientation information may indicate a 3D orientation of the vision sensor (e.g., a heading in the form of a pitch angle, a yaw angle, and a roll angle).

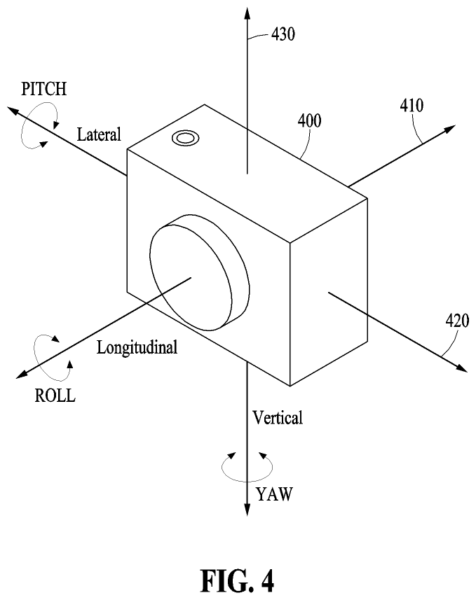

As noted above, each of the candidate calibration parameter sets may include a location delta and an orientation delta. Specifically, each candidate calibration parameter set may include a displacement according to a first axis, displacement according to a second axis, a displacement according to a third axis (the axes mutually perpendicular), a pitch angle difference, a yaw angle difference, and a roll angle difference. The pitch angle, yaw angle, and roll angle are described in detail below with reference to FIG. 4.

The electronic device may determine the units of candidate localization information by applying the respectively corresponding candidate calibration parameter sets to the localization information of the vision sensor. Specifically, the electronic device may determine the localization information (e.g., from prestored data or from a localization process). Given the localization information of the vision sensor, the electronic device may move the location information (of the localization information) by the displacements of the candidate calibration parameter sets according to the first, second, and third axes. Similarly, the electronic device may adjust the orientation information of the localization information. Specifically, the electronic device may adjust the orientation information by the pitch angle difference, yaw angle difference, and roll angle difference of the various candidate calibration parameter sets. To summarize, the electronic device may determine the units of candidate localization information by adjusting the localization information (i.e., generating permutations of the localization information) of the vision sensor by variations of the location and orientation designated by the candidate calibration parameter sets. Put another way, each candidate calibration parameter set may be used to form a corresponding candidate localization information by initializing the corresponding candidate localization information to be the same as the localization information (of the vision sensor) and then moving and/or reorienting initial localization information according to the location delta and/or the orientation delta of the candidate calibration parameter set.

In operation 320, the electronic device may obtain candidate static object regions respectively corresponding to the units of candidate localization information. Based on occupancy information mentioned above, for a given static object, the electronic device may obtain corresponding candidate static object regions. Each candidate static object region of the given static object may be a region in which a space occupied by the given static object (e.g., a static object space) as viewed from the viewpoint direction and location of the corresponding candidate localization information. If there are multiple static objects, this may be performed for each.

For example, each candidate static object region (e.g., of a given static object) may be determined based on a region in which the static object space (e.g., where the given static object is according to the occupancy information) is projected onto an image plane (a projection plane) corresponding to an image from the viewpoint direction of the candidate localization information corresponding to the candidate static object region.

In operation 330, the electronic device may determine, among candidate static object regions, the ground truth static object region based on the comparison between each candidate static object region with the static object region.

For example, the electronic device may determine, for each candidate static object region of a given static object, a similarity level between the static object region and a corresponding candidate static object region based on the number of pixels classified into the same class in the static object region and in a corresponding candidate static object region. For example, the static object region may be classified according to the class of the given static object (e.g., as determined by the occupancy information). In each candidate static object region of the given static object, a region (in the image onto which the static object space of the given static object of a certain class is projected) may be classified into a certain class.

The electronic device may select, as the ground truth static object region for a given static object, among the candidate static object regions corresponding to the given static object, the candidate static object region with the maximum similarity level.

For example, the electronic device may determine the ground truth static object region based on Equation 1 below.

$$M = {max}_{p ∈ P} ( S ( {I}_{seg} , {I}_{hdmap}^{p} ) ) \qquad Equation 1$$

I_{seg} denotes a static object region (segment) detected based on an object detection model (e.g., object detection model 220), I_{hdmap}^{p} denotes a candidate static object region determined based on a corresponding candidate localization information p, S(I_{seg}, I_{hdmap}^{p}) denotes a similarity level between I_{seg} and I_{hdmap}^{p}, P denotes a set including units of candidate localization information obtained based on respectively corresponding calibration parameter sets, p denotes candidate localization information, and M denotes a highest similarity level between (e.g., a degree of registration) a static object region detected based on the object detection model and a ground truth static object region. The electronic device may select, as ground truth static object region, candidate static object region having maximum similarity level with detected static object region (I_{seg}).

FIG. 4 illustrates an example of three axes based on a vision sensor or a moving object.

Three axes may be defined based on the orientation of a vision sensor 400 (or the orientation of a moving object (not shown) equipped with the vision sensor 400). For example, a longitudinal axis 410 of the vision sensor 400, a lateral axis 420 of the vision sensor 400, and a vertical axis 430 of the vision sensor 400 may coincide with physical axes of the vision sensor 400. The longitudinal axis 410 of the vision sensor 400 may be interpreted as substantially corresponding (e.g., equal) to an optical axis of the vision sensor 400.

In addition, the roll angle may be defined as an angle at which the vision sensor 400 rotates around the longitudinal axis 410 of the vision sensor 400. The pitch angle may be defined as an angle at which the vision sensor 400 rotates around the lateral axis 420 of the vision sensor 400. The yaw angle may be defined as an angle at which the vision sensor 400 rotates around the vertical axis 430 of the vision sensor 400.

As noted, the vision sensor 400 may be mounted on the moving object (not shown). For example, the vision sensor 400 may be mounted on the moving object so that the longitudinal axis 410 of the vision sensor 400 is parallel to and/or the same as a longitudinal axis (or a heading direction) of the moving object. In this case, since the vision sensor 400 also has the same movement as that of the moving object, an image obtained by the vision sensor 400 may include visual information that matches the location and orientation of the moving object. As referenced herein, the longitudinal axis, the lateral axis, and the vertical axis of the moving object may be interpreted as substantially corresponding to the longitudinal axis 410, the lateral axis 420, and the vertical axis 430 of the vision sensor 400, respectively.

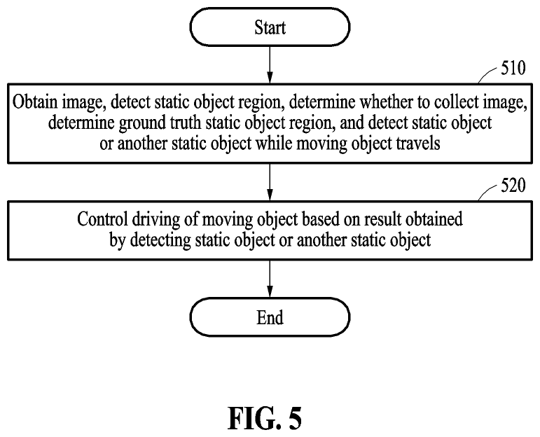

FIG. 5 illustrates an example of an operation of obtaining an image related to the driving of a moving object when a vision sensor is mounted on the moving object, according to one or more embodiments.

The vision sensor may be mounted on the moving object. An electronic device may include the vision sensor and may be mounted on the moving object together with the vision sensor.

In operation 510, while the moving object travels, the electronic device may obtain an image, detect a static object region therein, and determine whether to collect the image. To determine whether to collect the image, the electronic device may determine a ground truth static object region, and detect a static object or another static object. When the electronic device determined that there is degraded detection performance of the static object region for the image obtained while the moving object travels, the electronic device may collect the image as part of a training dataset.

In operation 520, the electronic device may control the driving of the moving object based on a result obtained by detecting the static object or another static object. For example, the electronic device may determine the speed or heading direction of the moving object. The electronic device may adjust the speed of the moving object up to a determined speed. The electronic device may adjust the steering of the moving object according to the determined speed. For example, the electronic device may detect the static object region corresponding to the static object (e.g., the lane line) and may adjust the speed, heading direction, or steering of the moving object so that the moving object maintains a corresponding lane based on the static object region of the moving object when it is determined that the moving object maintains the driving on the lane on which the moving object travels as a driving plan of the moving object (e.g., a vehicle). In other examples, the electronic device may detect the static object region corresponding to the static object (e.g., the lane on which the moving object travels and the lane line that defines another lane) and may adjust the speed, heading direction, or steering of the moving object so that the moving object changes a corresponding lane to another lane based on the static object region of the moving object when it is determined that the moving object changes the lane (e.g., the driving lane) on which the moving object travels to another lane as a driving plan of the moving object (e.g., a vehicle).

FIG. 6 illustrates an example of a method performed by a static object detection system, according to one or more embodiment.

To summarize the operations shown in FIG. 6, the static object detection system may include an electronic device 601 and a server 602. The electronic device 601 may collect and transmit at least a portion of a training dataset to the server 602, the server 602 may perform adaptive learning on an object detection model using the received at least a portion of the training dataset, and the electronic device 601 may receive a result obtained by performing adaptive learning on the object detection model from the server 602.

In operation 610, the electronic device 601 may detect a static object region from an image based on a first object detection model. Specifically, as described above with reference to FIGS. 1 to 5, the electronic device 601 may obtain the image as captured by a vision sensor and may detect the static object region corresponding to a static object by applying the first object detection model to the image. At this time, it is before the adaptive learning of the first object detection model.

In operation 620, the electronic device 601 may collect the image and a ground truth static object region as part of the training dataset. As described above with reference to FIGS. 1 to 5, the electronic device 601 may determine, from the image, whether to collect the image based on an accuracy level of the static object region (a region determined based on the first object detection model), determine the ground truth static object region based on occupancy information and based on the localization information of the vision sensor, and collect as a training pair the image and the ground truth static object region.

In operation 630, the electronic device 601 may transmit the training pair (the image and the ground truth static object region) to the server 602, which the server 602 may receive.

The electronic device 601 may further transmit to the server 602 information of the first object detection model to the server 602, e.g., a structure or parameter of the model. The server 602 may further receive the information of the first object detection model from the electronic device 601. However, transmitting the information of the first object detection model to the server 602 is not required; the server 602 may store the information of the first object detection model in a memory of the server 602.

In operation 640, the server 602 may perform adaptive learning on the first object detection model using the training dataset including the image and the ground truth static object region. The adaptive learning on the first object detection model may be supervised learning using the ground truth static object region. For example, the server 602 may locally determine the static object region based on a result obtained by applying the server's first object detection model to the image. The server 602 may determine a loss value based on the difference between the static object region and the ground truth static object region. The server 602 may change a parameter of the first object detection model based on the loss value. For example, the server 602 may repeatedly apply backpropagation to minimize the loss value. Hereinafter, the object detection model at least a portion of the parameter thereof is changed, (that is, the adaptively learned object detection model), may be referred to as a second object detection model.

In operation 650, the server 602 may transmit information on a result of the adaptive learning to the electronic device 601, which the electronic device 601 may receive. The information on the result of the adaptive learning may include a variation of a parameter value according to adaptive learning and/or a parameter value changed according to adaptive learning. For example, the parameter value may include weights of nodes of the second object detection model.

In operation 660, the electronic device 601 may change the first object detection model to the second object detection model based on the information on the result of the adaptive learning. Again, the second object detection model may be a derivation of the first object detection model as adaptively learned based on the image and the ground truth static object region of the first object detection model.

In operation 670, the electronic device 601 may detect the static object (or another static object) from another image captured by the vision sensor, and may do so using the second object detection model.

As described above with reference to FIG. 1, the adaptively learned second object detection model may have improved object detection performance from images captured in a worse environment than an environment before the adaptive learning. Accordingly, the electronic device 601 may detect the static object (or another static object) more accurately from the other image using the adaptively learned second object detection model than the first object detection model before adaptive learning, even when the other image is captured in a poor environment.

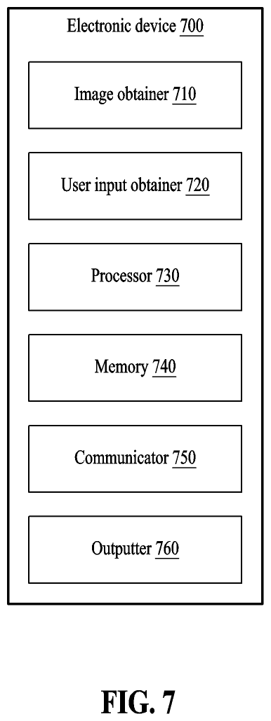

FIG. 7 illustrates an example configuration of an electronic device, according to one or more embodiments.

An electronic device 700 (e.g., the electronic device 601 of FIG. 6) may include an image obtainer 710, a user input obtainer 720, a processor 730, a memory 740, a communicator 750, and an outputter 760. The processor 730 may be any one of the types of processors described herein, or it may be a combination of any of those processors.

The image obtainer 710 may obtain an image captured by a vision sensor. The image obtainer 710 may be/include the vision sensor. The image obtainer 710 may generate an image of a physical region in front of the electronic device 700. The image obtainer 710 may be implemented in conjunction with the communicator 750 and may receive sensing data generated from a vision sensor outside of the electronic device 700 and/or an image based on the sensing data.

The user input obtainer 720 may obtain a user input. The user input obtainer 720 may be implemented as a physical button and may obtain the user input when a push is detected on the physical button. The user input obtainer 720 may be implemented in conjunction with the outputter 760. The user input obtainer 720 may include, for example, a touch display.

The processor 730 may obtain an image through the image obtainer 710. The processor 730 may detect a static object region based on a result obtained by applying an object detection model to the image. The processor 730 may determine whether to collect the image based on the detected static object region. The processor 730 may determine a ground truth static object region from occupancy information when it is determined to collect the image. The processor 730 may detect the static object or another static object from another image using an adaptively learned object detection model.

The memory 740 may temporarily and/or permanently store at least one of the image, the object detection model, the static object region, the occupancy information, the ground truth static object region, or another image. The memory 740 may store instructions for obtaining the image, detecting the static object region, determining whether to collect the image, determining the ground truth static object region, and/or detecting the static object (or another static object) from another image. However, this is only an example, and information stored in the memory 740 is not limited thereto.

The communicator 750 may transmit and receive at least one of the image, the object detection model, the static object region, the occupancy information, the ground truth static object region, or another image to and from an external device. The communicator 750 may establish a wired communication channel and/or a wireless communication channel with an external device (e.g., another electronic device or a server) and may, for example, establish communication with the external device through cellular communication, short-range wireless communication, local area network (LAN) communication, Bluetooth, wireless fidelity (Wi-Fi) direct or infrared data association (IrDA), or a long-range communication network such as a legacy cellular network, a fourth generation (4G) and/or fifth generation (5G) network, next generation communication, the Internet, or a computer network (e.g., a LAN or wide area network (WAN)).

The outputter 760 may visualize at least one of the image, the static object region, or the ground truth static object region. The outputter 760 may include a display.

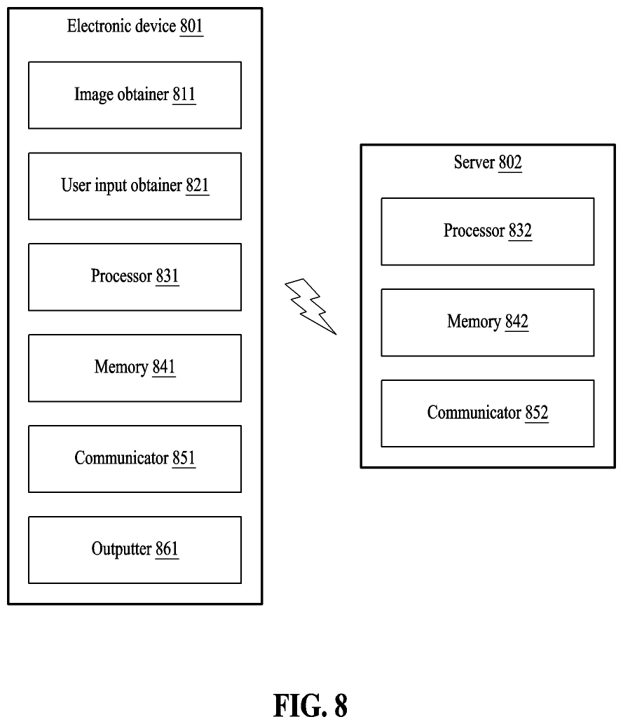

FIG. 8 illustrates an example configuration of an object detection system, according to one or more embodiments.

The object detection system may include an electronic device 801 (e.g., the electronic device 601 of FIG. 6) and a server 802 (e.g., the server 602 of FIG. 6).

The electronic device 801 may include an image obtainer 811 (e.g., the image obtainer 710 of FIG. 7), a user input obtainer 821 (e.g., the user input obtainer 720 of FIG. 7), a processor 831 (e.g., the processor 730 of FIG. 7), a memory 841 (e.g., the memory 740 of FIG. 7), a communicator 851 (e.g., the communicator 750 of FIG. 7), and an outputter 861 (e.g., the outputter 760 of FIG. 7).

The server 802 may include a processor 832, a memory 842, and a communicator 852.

The processor 832 may obtain an image and a ground truth static object region through the communicator 852. The processor 832 may perform adaptive learning on the first object detection model based on a training dataset including the image and the ground truth static object region. The processor 832 may transmit information (e.g., information on the second object detection model) on a result of the adaptive learning to the electronic device 801.

The memory 842 may temporarily and/or permanently store at least one of the image, the ground truth static object region, the first object detection model, the second object detection model, or the result of adaptive learning. The memory 842 may store instructions for obtaining the image and the ground truth static object region, perform adaptive learning on the first object detection model, and/or transmit the result of adaptive learning to an external device (e.g., the electronic device 801 of FIG. 8). However, this is only an example, and the information stored in the memory 842 is not limited thereto.

The communicator 852 may transmit and receive at least one of the image, the ground truth static object region, the first object detection model, the second object detection model, or the result of adaptive learning to and from an external device (e.g., the electronic device 801 of FIG. 8). The communicator 852 may establish a wired communication channel and/or a wireless communication channel with an external device (e.g., the electronic device 801 of FIG. 8 and may, for example, establish communication with the external device (e.g. the electronic device 801 of FIG. 8) through cellular communication, short-range wireless communication, LAN communication, Bluetooth, Wi-Fi or IrDA, or a long-range communication network such as a legacy cellular network, a 4G and/or 5G network, next generation communication, the Internet, or any data network (e.g., a LAN or WAN)).

The examples described herein may be implemented using a hardware component, a software component, and/or a combination thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The computing apparatuses, the vehicles, the electronic devices, the processors, the memories, the image sensors, the vehicle/operation function hardware, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROM, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by an electronic device, the method comprising:
obtaining an image captured by a sensor;
detecting, in the image, a static object region corresponding to a static object of the image, wherein the detecting is performed by applying an object detection model to the image;
determining whether to collect the image as part of a training dataset based on an accuracy level of the detected static object region; and
determining a ground truth static object region for the static object of the image from space-occupancy information of the static object with respect to the image collected as part of the training dataset.

2. The method of claim 1, wherein the determining of whether to collect the image comprises:
determining a reference static object region in which a space occupied by the static object is viewed from a viewpoint and viewing direction of the sensor, based on the space-occupancy information of the static object and localization information of the sensor, the localization information comprising a location and orientation of the sensor; and
determining the accuracy level of the detected static object region based on a comparison between the static object region and the reference static object region.

3. The method of claim 2, wherein
the detecting of the static object region comprises detecting sub-regions of the image respectively corresponding to static objects of the image, including the static object,
determining reference static object sub-regions of the static objects from the detected sub-regions, and
the determining of the accuracy level of the detected static object region comprises:
determining detection states for the respective static objects, wherein each static object's detection state is determined based on its detected sub-region and its reference sub-region, and wherein static object's detection state indicates whether the detection of the static object is valid or invalid; and
determining the accuracy level of the detected static object region based on a ratio of a number of valid detection states and a number of invalid detection states.

4. The method of claim 1, further comprising:
displaying the detected static object region,
wherein the determining of whether to collect the image is based on detecting a user input requesting a collection of the image.

5. The method of claim 1, wherein the determining of the ground truth static object region comprises:
obtaining, for candidate calibration parameter sets, respectively corresponding units of candidate localization information, each obtained by calibrating localization information of the sensor using a corresponding candidate calibration parameter set;
obtaining candidate static object regions of the respective units of candidate localization information, wherein each candidate static object region is obtained from a view of a three-dimensional space occupied by the static object as viewed from a viewpoint direction of the corresponding candidate localization information; and
determining, from among the candidate static object regions, the ground truth static object region based on comparison between each candidate static object region with the static object region.

6. The method of claim 5, wherein the determining of the ground truth static object region comprises:
determining, for each candidate static object region, a similarity level between the static object region and a corresponding candidate static object region based on a number of pixels classified into the same class in the static object region and in a corresponding candidate static object region; and
determining, to be the ground truth static object region, from among the candidate static object regions, a candidate static object region with a maximum similarity level.

7. The method of claim 5, wherein each candidate calibration parameter set comprises a position delta and an orientation delta.

8. The method of claim 1, wherein
the sensor is mounted on a moving object, and
the obtaining the image, the detecting the static object region, the determining whether to collect the image, the determining the ground truth static object region, and detecting an object are performed while the moving object travels, wherein the object is the static object or another static object.

9. The method of claim 8, further comprising controlling driving of the moving object based on a result obtained by the detecting of the object.

10. The method of claim 1, wherein the method further comprises:
determining a loss value for adaptive learning based on a difference between the static object region and the ground truth static object region; and
updating a parameter of the object detection model based on the determined loss value for adaptive learning.

11. A method performed by an electronic device, the method comprising:
obtaining an image captured by a sensor; and
detecting, in the image, a static object region corresponding to a static object of the image, wherein the detecting is performed by applying an object detection model to the image,
wherein the object detection model is an adaptively learned model, based on a training dataset, which comprises a training image with respect to a training static object, and a ground truth static object region mapped to the training image, and
wherein the ground truth static object region is determined to be a region corresponding to the training static object of the training image from space-occupancy information of the training static object.

12. A non-transitory computer-readable storage medium storing instructions that, when executed by a processor, cause the processor to perform the method of claim 11.

13. An electronic device comprising:
one or more processors configured to:
obtain an image captured by a sensor, detect in the image a static object region corresponding to a static object of the image, wherein the detecting is performed by applying an object detection model to the image;
determine whether to collect the image as part of a training dataset based on an accuracy level of the detected static object region; and
determine a ground truth static object region for the static object of the image from space-occupancy information of the static object with respect to the image collected as part of the training dataset.

14. The electronic device of claim 13, wherein the one or more processors are further configured to:
determine a reference static object region in which a space occupied by the static object is viewed from a viewpoint and viewing direction of the sensor, based on the space-occupancy information of the static object and localization information of the sensor, the localization information comprising a location and orientation of the vision sensor; and
determine the accuracy level of the detected static object region based on a comparison between the static object region and the reference static object region.

15. The electronic device of claim 14, wherein the one or more processors are configured to:
detect the static object region comprising partial regions respectively corresponding to static objects, including the static object, that are represented in the image;
determine the reference static object region, which comprises reference sub-regions respectively corresponding to the static objects;
determine, for each of the static objects, whether detection for a corresponding static object is valid or invalid, based on a partial region and a partial reference region corresponding to a corresponding static object; and
determine the accuracy level of the detected static object region based on a number of validly detected static objects.

16. The electronic device of claim 13, wherein the one or more processors are configured to:
obtain, for each of candidate calibration parameter sets, respectively corresponding units of candidate localization information, each obtained by calibrating localization information of the sensor using a corresponding candidate calibration parameter set, the localization information of the sensor comprising a position and an orientation;
obtain candidate static object regions of the respective units of candidate localization information, wherein each candidate static object region is obtained from a view of a three-dimensional space occupied by the static object as viewed from a viewpoint direction of the corresponding candidate localization information; and
determine, from among the candidate static object regions, the ground truth static object region based on comparison between each candidate static object region with the static object region.

17. The electronic device of claim 16, wherein the one or more processors are configured to:
determine, for each candidate static object region, a similarity level between the static object region and a corresponding candidate static object region based on a number of pixels classified into the same class in the static object region and a corresponding candidate static object region; and
determine, to be the ground truth static object region, from among the candidate static object regions, a candidate static object region with a maximum similarity level.

18. The electronic device of claim 16, wherein each of the candidate calibration parameter sets comprises a position delta and an orientation delta, and wherein each unit of candidate localization information is determined by changing the position and orientation of the localization information by the position delta and the orientation delta of a corresponding candidate localization parameter set.

19. The electronic device of claim 13, wherein
the sensor is mounted on a moving object, and
the one or more processors are configured to control driving of the moving object based on a result obtained by detecting the static object or another static object.

20. The electronic device of claim 13, wherein the one or more processors are configured to:
determine a loss value for adaptive learning based on a difference between the static object region and the ground truth static object region; and
update a parameter of the object detection model based on the determined loss value for adaptive learning.
